(19) United States
(12) Patent Application Publication
(10) Pub. No.: US 2026/0320552 A1
(43) Pub. Date: Oct. 15, 2026

(54) Automated Generation of Distributor-Specific Bills of Material Using Machine Learning and Multi-Document Analysis

(71) Applicant: Argus Industrial Solutions, LLC, Austin, TX (US)

(72) Inventors: Logan J. Weber, Austin, TX (US); Marco Soto, Austin, TX (US)

(21) Appl. No.: 19/466,309

(22) Filed: Jan. 31, 2026

Related U.S. Application Data
(63) Continuation-in-part of application No. 19/174,839, filed on Apr. 9, 2025.

(51) Int. Cl. G06Q 10/0875; G06V 10/764; G06V 30/10

(52) U.S. Cl. CPC G06Q 10/0875; G06V 10/764; G06V 30/10

(57) ABSTRACT

An automated system generates distributor-specific bills of material (BOMs) for electrical switchgear by analyzing heterogeneous electrical documentation through integrated machine learning (ML), spatial optical character recognition (OCR), and rules-based validation. The system ingests electrical submittal packages (e.g., panel schedules, one-line diagrams) and applies a Detectron2 ML model to detect components (e.g., breakers, disconnects) in vector drawings. A spatial OCR engine (EasyOCR) extracts text and correlates labels with component positions. A rules engine enforces distributor preferences (e.g., copper bussing defaults), performs NEC compliance checks, and resolves ambiguities via error prevention modules. The system outputs structured BOMs with grouped part numbers, formatted for ERP integration, and provides override suggestions for unresolved data. By automating component detection, material specification, and compliance validation, the system reduces manual errors and streamlines switchgear quoting processes for electrical distributors.

### CROSS-REFERENCE TO RELATED APPLICATIONS

See Application Data Sheet (ADS).

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO AN APPENDIX SUBMITTED ON A COMPACT DISC AND INCORPORATED BY REFERENCE OF THE MATERIAL ON THE COMPACT DISC

Not applicable.

### STATEMENT REGARDING PRIOR DISCLOSURES BY THE INVENTOR OR A JOINT INVENTOR

Reserved for a later date, if necessary.

### BACKGROUND OF THE INVENTION

### Field of Invention

The disclosed subject matter relates to automated systems for processing electrical documentation. The disclosure is specifically related to methods and systems for generating distributor-specific bills of material (BOMs) by parsing electrical submittal packages to identify and process key electrical documents including one-line diagrams, riser diagrams, and panel schedules. The subject combines computer vision, machine learning, and electrical engineering to automate error detection, component identification, and BOM generation tailored to electrical distributors'workflows. The system integrates optical character recognition (OCR), spatial text analysis, and rules-based part number generation to address inefficiencies in manual switchgear quoting processes. Unlike prior semi-automated tools requiring manual document selection, the system automatically identifies electrical-specific documents (e.g., panel schedules or electrical riser diagrams in PDFs containing mixed content) while excluding non-essential materials (e.g., plumbing diagrams, structural drawings). This targeted processing enables comprehensive BOM generation with distributor-specific features such as grouped part numbers, missing component suggestions, and configurable output templates formatted for ERP integration.

### Listing of the Related Art

The following references might be to be related to the disclosed subject matter. 6606731 (issued Aug. 12, 2003) by Baum et al. discloses an “intelligent wiring diagram system.”
11030709 (issued Jun. 8, 2021) by McLinden et al. discloses a “method and system for automatically creating an assigning assembly labor activities (ALAS) to a Bill of Materials (BOM).”
11423360 (issued Aug. 23, 2022) by Blackburn et al. discloses a “digital asset system for management of projects and materials.”
20180364281 (published Dec. 20, 2018) by Zhang et al. discloses an electrical riser diagram at FIG. 3 and ¶[0035].
20240273479 (published Aug. 15, 2024) by Teeple et al. discloses an interactive “one-line diagram” at FIG. 2 and ¶[0012].
20240378332 (published Nov. 14, 2024) by Butts, Jr. discloses a “dynamic conduit design generation system and method.”
20210073449 (published Mar. 11, 2021) by Segev et al. discloses “structural design systems and methods for floor plan simulation and modeling in mass customization of equipment.” See [0654].
20240420047 (published Dec. 19, 2024) by Kumar et al. discloses a “method, system and platform for dynamic bill-of-materials generation.”
20230297911 (published Sep. 21, 2023) by Wolff et al. discloses an “automated construction materials management platform.”
20240193490 (published Jun. 13, 2024) by Sawaf et al discloses a “machine learning model generator.”
20240127146 (published Apr. 18, 2024) by Hardy et al. discloses a translation decision assistant.
WO2006102419A2 (published Sep. 28, 2006) by Blades disclose an “automated electrical wiring inspection system.”
EP2551807A2 (published Jan. 30, 2013) by Zakrzwski et al. discloses an “automated system for digitized product management.”
Website:www.opendrawing.ai
See the Information Disclosure Statements (IDS) of record.

### BACKGROUND OF THE INVENTION

Traditional methods for generating BOMs for electrical switchgear require quote specialists at distributors to manually review complex documentation, including panel schedules, one-line diagrams, and technical specifications. This time-consuming, error-prone process costs distributors significant labor hours, introduces costly mistakes (such as incorrectly specifying copper vs. aluminum bussing), and creates bottlenecks in the quoting workflow. Existing solutions, such as OpenDrawing.ai, focus on semi-automated BOM generation for engineers and procurement teams but lack distributor-centric features like ERP integration, part number grouping, or error prevention. Other prior art, including US20240420047A1, relies on predefined CAD/BIM models rather than raw electrical documents, while EP2551807A2 requires manual template updates in product lifecycle management systems.

The disclosed subject matter addresses these gaps by automating the extraction of critical data from unstructured electrical submittal packages using machine learning (ML) models (e.g., Detectron2 for vector diagram analysis) and spatial optical character recognition (OCR) (e.g., EasyOCR for contextual text recognition). Unlike OpenDrawing. ai, which requires manual clarifications for ambiguous data and focuses on engineer-facing manufacturer comparisons, the disclosed system automates error resolution and tailors outputs exclusively to distributor workflows (e.g., ERP integration, part number grouping). Unlike other prior systems, the system disclosed now incorporates distributor-specific rules for material defaults (e.g., copper vs. aluminum bussing), panel tracking to prevent duplicate entries, and automated error resolution for ambiguous specifications. By processing entire job packages—including panel schedules, transformer schedules, roof structural drawings and plumbing diagrams—the system eliminates time-consuming manual reviews while ensuring compliance with electrical codes and distributor preferences. This approach represents a significant advancement over conventional methods, which often require iterative corrections and lack integration with distributor ERP systems for seamless quote generation.

### SUMMARY OF THE INVENTION

This specification presents a novel automated system that transforms the labor-intensive process of generating bills of material (BOMs) for electrical switchgear into an efficient, error-reducing solution through advanced technology integration. The disclosed system addresses the specific needs of electrical distributors by taking electrical documents, automatically identifying panel schedules, associated schedules, and one-line diagrams, and then extracting critical information using computer vision and ML to create comprehensive item profiles for each required switchgear component. From these profiles, it builds a complete bill of materials tailored to distributor workflows and preferences. Unlike engineer-focused solutions like OpenDrawing.ai, this system processes entire submittal packages without requiring manual page selection, automatically suggests missing components, groups parts, and integrates seamlessly with distributor ERP systems—significantly reducing quote preparation time and eliminating costly specification errors. In a preferred embodiment, the disclosed system addresses the specific needs of electrical distributors by analyzing electrical documents (including panel schedules and one-line diagrams) to automatically identify assembly-specific component groups using computer vision and ML. The system further integrates distributor workflows by automatically suggesting missing assembly-specific components (e.g., main lugs for detected panels), formatting outputs for ERP compatibility, and processing entire submittal packages without manual page selection—reducing quote preparation time by 68% compared to conventional methods in experimental trials.

The disclosed subject matter provides an automated system for generating distributor-specific bills of material (BOMs) for electrical switchgear, comprising four integrated layers (FIGS. 1, 3):
1. Input Layer: Receives electrical submittal documents (panel schedules, one-line diagrams) and distributor preferences (e.g., copper/aluminum bussing defaults, ERP templates).
2. Processing Layer:
   Spatial OCR Engine: Uses EasyOCR with coordinate mapping to correlate text labels (e.g., “225A”) with components in vector drawings (FIGS. 2A-B).
   ML Component Detector: Employs a Detectron2 model trained on annotated electrical datasets to identify breakers, disconnects, and transformers.
   Rules Engine: Enforces compliance (e.g., validating ampacities per NEC 240.6(A)) and generates part numbers (e.g., “SQD-CB20-1P”) by concatenating manufacturer codes with component attributes.
      Error Prevention Module: Cross-references distributor inventory to substitute unavailable components with compliant alternatives (e.g., suggesting 40A fuses for out-of-stock 30A units per NEC 240.4(B)).
3. Output Layer: Generates BOMs with grouped part numbers (aggregating identical components within panels) and NEC compliance reports, formatted for ERP systems (e.g., SAP/Oracle CSV templates).
4. Integration Layer: Directly exports BOMs to distributor ERP systems and implements a feedback loop to refine rules based on user overrides.

The system automates error-prone manual processes by combining spatial OCR analysis of panel schedules (FIG. 2B) with ML-driven component detection in riser diagrams (FIG. 2A). A key innovation lies in its inventory-aware substitution logic, which suggests distributor-stocked alternatives when detected components are unavailable, ensuring compliance with both manufacturer specifications and NEC standards. The method further includes training the Detectron2 model on spatial relationships between breakers and panel identifiers, enabling accurate BOM generation from raw electrical documents.

### BRIEF DESCRIPTION OF THE SEVERAL VIEWS OF THE DRAWINGS

Other objectives of the disclosure will become apparent to those skilled in the art once the invention has been shown and described. The manner in which these objectives and other desirable characteristics can be obtained is explained in the following description and attached figures in which:

FIG. 1 is a system architecture diagram;

FIG. 2A is an example input document;

FIG. 2B is another example input document;

FIG. 3 is a workflow diagram for BOM generation; and,

FIG. 4 is an output BOM;

FIG. 5A is another example input document;

FIG. 5B is another example input document;

FIG. 6 is another output BOM;

FIG. 7 is a panel-schedule attribute region;

FIG. 8 is a panel-schedule breaker-row analysis and junk-value filtering view;

FIG. 9 is an E-sheet page filtering example;

FIG. 10 is a user upload interface;

FIG. 11 is a loading interface; and,

FIG. 12 is a output interface.

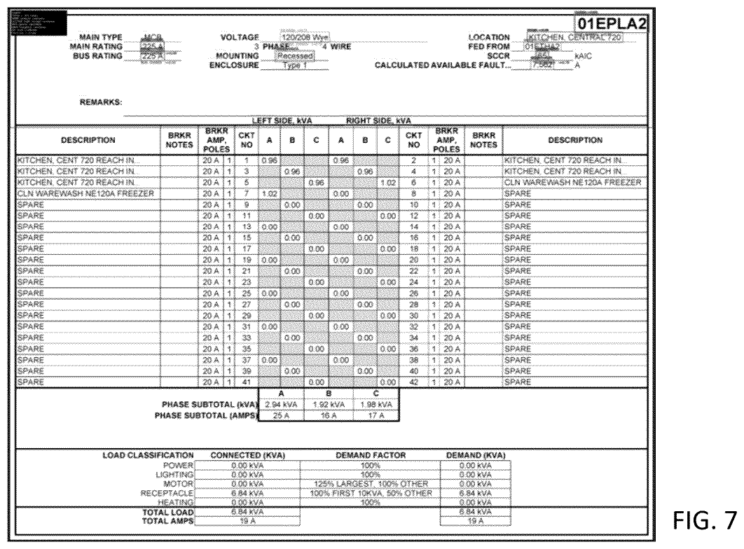

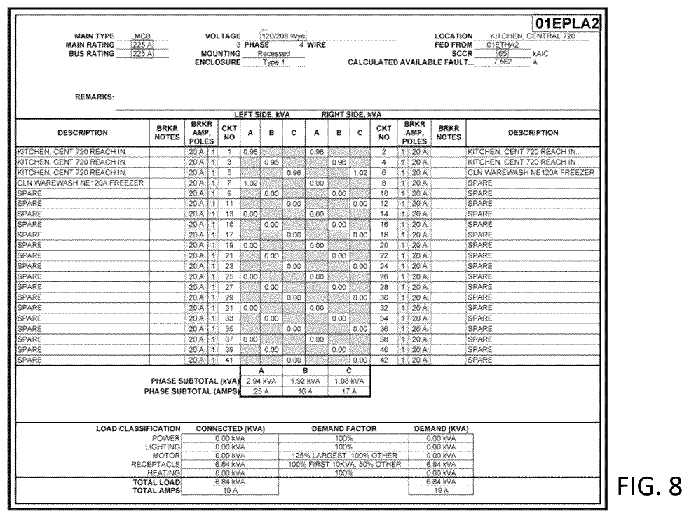

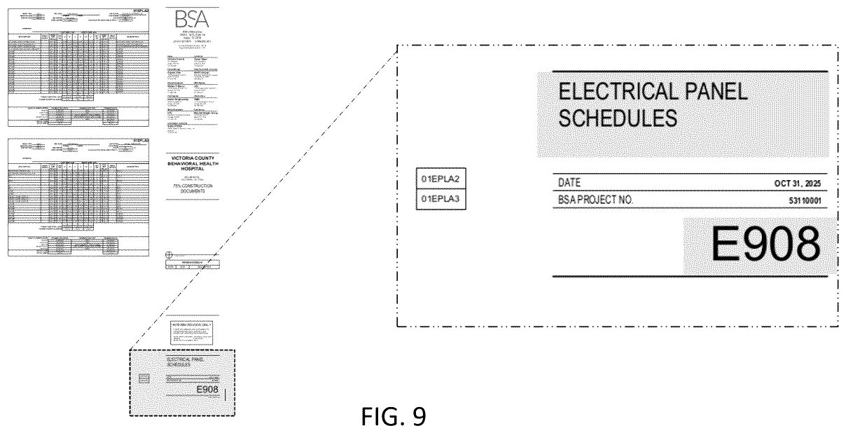

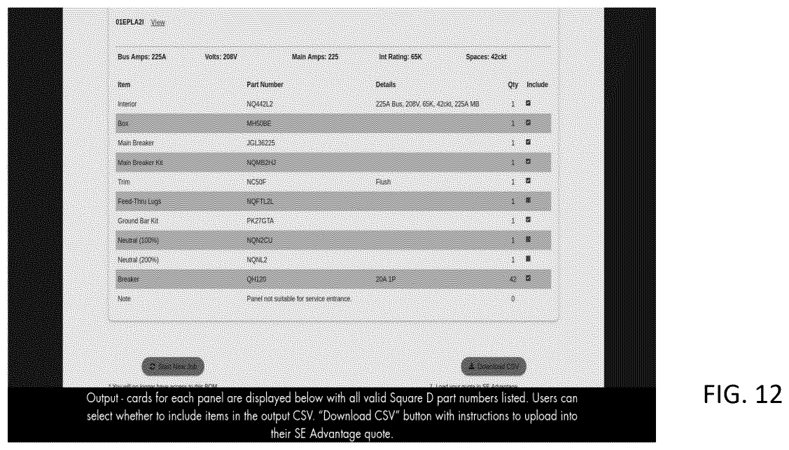

In some embodiments, additional figures illustrate internal analysis stages of the automated system. FIG. 7 is an annotated view of a detected panel schedule showing panel-attribute regions and candidate breaker column locations. FIG. 8 is an annotated view of breaker-row analysis, including poles/amps column selection and junk value filtering for unreliable breaker detections. FIG. 9 is a corner crop view of an architectural or engineering drawing sheet illustrating detection of “E-sheet” identifiers using OCR. Also discussed is an example of page level electrical sheet filtering to panel schedule and equipment-schedule pages. FIG. 12 is a user interface view of rules-engine output, showing manufacturer specific panel configurations and grouped part numbers for each detected panel.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

This is a specification of an automated system to generate distributor-specific BOMs for electrical switchgear by analyzing heterogeneous electrical documentation through integrated ML, spatial OCR, and rules-based validation. The system ingests electrical submittal packages and applies an ML model to detect components in vector drawings. A spatial OCR engine extracts text and correlates labels with component positions. A rules engine enforces distributor preferences, performs compliance checks (e.g., NEC compliance checks), and resolves ambiguities via error prevention modules. The system outputs structured BOMs with grouped part numbers, formatted for ERP integration, and provides override suggestions for unresolved data. The more specific details of the preferred embodiment of the system are disclosed with reference to the figures.

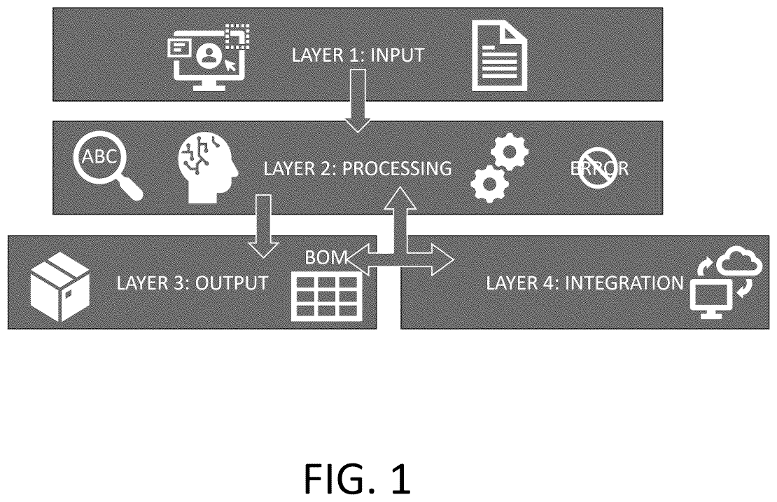

FIG. 1 is a System Architecture Diagram. The illustrated system architecture illustrated should suitably provide a comprehensive overview of the automated bill of materials (BOM) generation system for e.g. electrical switchgear. The architecture comprises four primary layers: an Input Layer, a Processing Layer, an Output Layer, and an Integration Layer, each contributing to the end-to-end automation of distributor-specific BOM creation.
1. Input Layer. The Input Layer serves as the entry point for raw electrical documentation and user-defined preferences. Electrical Submittal Documents, including panel schedules, one-line diagrams, transformer schedules, and supporting technical specifications (in PDF or vector formats), are uploaded via a User Interface portal. This interface allows distributors to select preferences such as ERP template formats (e.g., CSV formats compatible with SAP, Oracle, or other distributor-specific systems), material defaults (e.g., copper vs. aluminum bussing), manufacturer preferences (e.g., Square D, Eaton, or Siemens), and compliance requirements. The portal ensures seamless ingestion of unstructured documents while capturing distributor-specific rules critical for downstream processing. Users configure material defaults (e.g., copper vs. aluminum bussing) and output templates via dropdown menus prior to document upload. These selections are applied as rules during processing, overriding ambiguous or missing specifications in the source documents, which prevents costly specification errors that would otherwise require complete reordering of components.
2. Processing Layer. The Processing Layer executes the core automation logic through four interconnected subsystems:—OCR Engine: Utilizes EasyOCR with spatial coordinate mapping to extract text and numerical data from electrical diagrams and schedules. This subsystem identifies and correlates labels, ratings, and specifications (e.g., breaker amperage, fuse types) with their spatial positions in vector drawings. ML-Based Component Detector: Employs a Detectron2 machine learning model to detect electrical components (e.g., circuit breakers, fused disconnects) and their spatial relationships within diagrams. The ML-Based Component Detector employs a Detectron2 model to identify 2D vector drawings of electrical components (e.g., disconnects, breakers) within documents. Detected regions, including surrounding areas to capture contextual data, are converted to PNG images for OCR processing. The OCR Engine utilizes EasyOCR to extract text, assigning spatial coordinates to correlate labels (e.g., ‘poles,’ ‘amperage’) with corresponding component data. For example, text under a ‘poles’ column header is mapped to breaker pole counts in panel schedules. The model analyzes vector graphics to distinguish components and map their connectivity, enabling accurate BOM itemization.—Rules Engine: Applies distributor-specific logic, such as material defaults (e.g., automatic copper bussing selection unless specified otherwise) and NEC compliance checks. This engine generates standardized part numbers by cross-referencing detected components with distributor-specific catalogs.—Error Prevention Module: Flags ambiguities (e.g., missing fuse ratings) and provides override suggestions to resolve conflicts. This subsystem ensures compliance with distributor requirements while maintaining audit trails for manual corrections.
3. Output Layer. The Output Layer generates finalized deliverables tailored to distributor workflows. The Distributor-Specific BOM aggregates components into a structured bill of materials, grouping identical part numbers and formatting outputs for compatibility with ERP systems (e.g., CSV, Excel). A Submittal Package bundles the BOM with supporting documentation, such as error logs and compliance reports, to streamline quote approval processes.
4. Integration Layer. The Integration Layer bridges the system with external platforms and user workflows. ERP Connectivity enables direct export of BOMs to distributor ERP systems (e.g., SAP, Oracle), eliminating manual data entry. A User Feedback Loop provides an interface for reviewing automated suggestions, overriding system decisions, and refining rules-engine logic based on historical corrections.

As shown in FIG. 1, this layered architecture suitably enables fully automated processing of heterogeneous electrical documentation while ensuring distributor-specific customization and error resilience. The integration of machine learning, spatial OCR, and rules-based validation may distinguish the system from conventional BOM generation tools by addressing the unique challenges of electrical switchgear quoting.

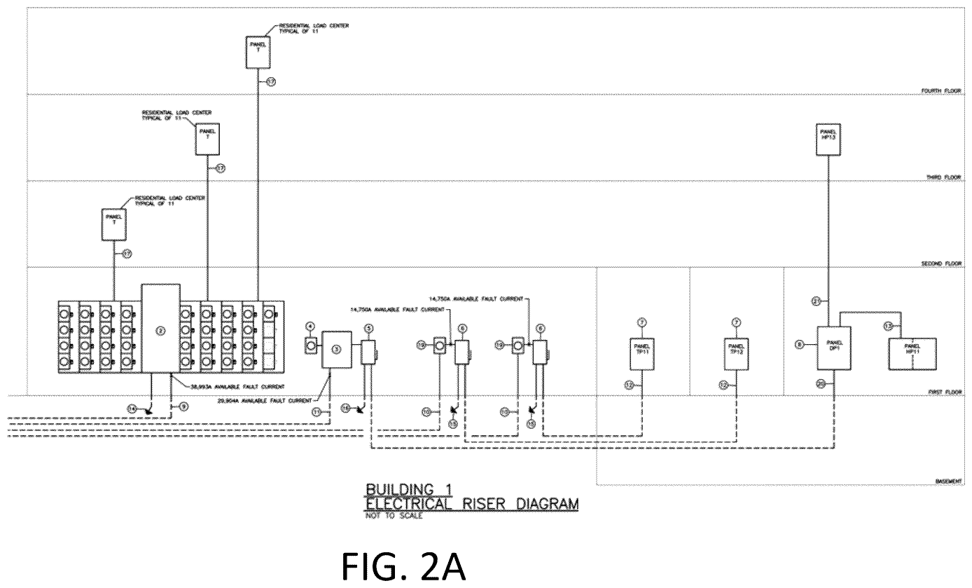

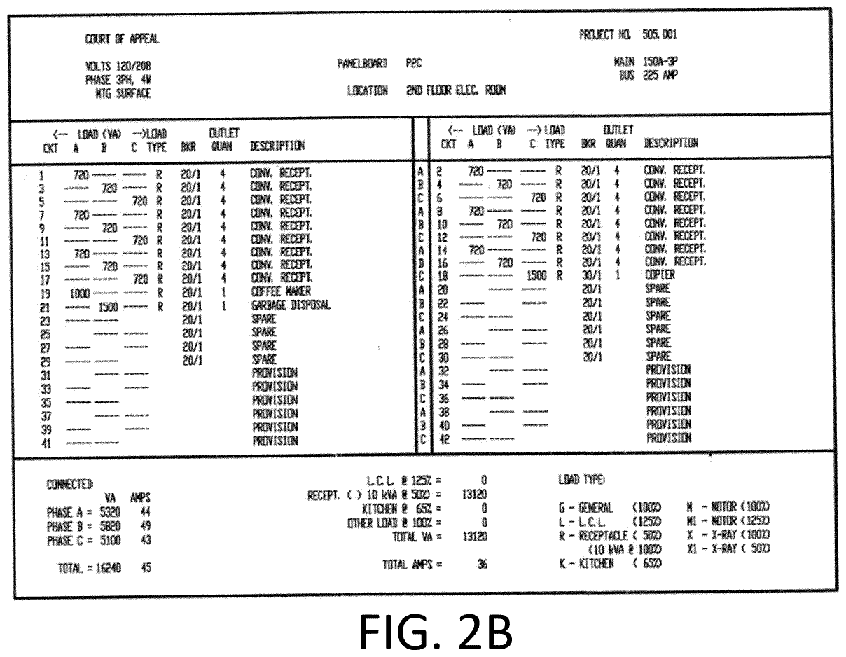

FIG. 2A is an example of an electrical riser diagram for a building with a basement and four floors. This riser diagram illustrates the vertical distribution of electrical systems within the building. For the represented multi-level structures, the diagram shows how power flows from the main service entrance to various floors or levels. An emphasis is placed on the physical layout and routing of electrical components, such as feeders, bus risers, panelboards, transformers, branch circuits, across the different building levels. The diagram features a vertical orientation showing floor-by-floor connections and may include physical locations of components like electrical closets, shafts and vaults. In some cases, the riser diagram depicts other systems like alarm or telecommunication wiring.

FIG. 2B are several examples of a panel schedule for five of the panels depicted in FIG. 2A. Each panel schedule is a detailed table that provides information about the circuits and electrical loads connected to a specific electrical panel. It is essentially a “map” of the panel's internal configuration, showing how power is distributed to various circuits and equipment. Panel schedules are used by electricians, engineers, and inspectors to understand the layout of the electrical system and ensure it meets design and safety requirements. The following information is typically included in such schedules:

### Panel Name or Identifier:

Each schedule corresponds to a specific panel, such as “Panel LP-1.”

This helps identify which part of the building the panel serves.

### Circuit Numbers:

Each row in the schedule represents an individual circuit.

Circuit numbers (e.g., 1, 2, 3) help locate the circuit's position within the panel.

### Descriptions:

A description of what each circuit powers, such as “Lighting,” “Receptacles,” or “HVAC.”

This provides clarity on what equipment or area each circuit serves.

### Amperage Ratings:

The current rating for each circuit breaker (e.g., 20A, 30A).

Ensures that circuits are not overloaded beyond their capacity.

### Poles:

Indicates whether the breaker is single-pole (1P), double-pole (2P), or three-pole (3P).

This reflects how many phases of electricity the breaker connects to.

### Voltage Levels:

Specifies whether circuits are single-phase or three-phase and their voltage levels (e.g., 120V, 240V).

Important for compatibility with connected equipment.

### Spare Circuits:

Empty rows indicating available slots for future circuits.

Useful for planning system expansions.

### Additional Notes:

May include material specifications (e.g., copper or aluminum bussing) or compliance codes (e.g., NEC references).

FIGS. 2A and 2B illustrate an exemplary input document (e.g., a panel schedule or one-line diagram) and the system's automated detection and extraction process for generating distributor-specific bills of material (BOMs). FIG. 2A depicts an annotated electrical panel schedule, demonstrating how the system might identify and extract data points using ML and OCR. Highlighted regions and labels show:
1. Detected Components:
   Circuit breakers (e.g., “125A Main Breaker”) and fused disconnects (e.g., “60A Fused Disconnect”) are outlined and labeled with their amperage ratings.
   Panel identifiers (e.g., “Panel LP-1”) are detected via OCR and linked to their corresponding components.
2. Extracted Data Fields:
   Amperage ratings (e.g., “125A,” “60A”) are extracted and mapped to manufacturer part numbers using the Rules Engine.
   Material specifications (e.g., “Cu” for copper bussing) are inferred from supporting documentation or default rules.
3. Spatial Relationships:
   Arrows indicate how components are connected across multiple pages (e.g., feeder links between panels).
   Spatial coordinates from EasyOCR correlate text labels (e.g., “225A”) with their physical positions in vector diagrams.

FIG. 2B illustrates a page from a set of electrical drawings, specifically showing panel schedules. Suitably, panel schedules are detailed tables that list the circuits, loads, and associated electrical components (e.g., breakers, fuses) for a given electrical panel. These schedules typically include information such as:
Panel Name or Identifier (e.g., “Panel LP-1”).
Circuit Numbers: The numbering of individual circuits within the panel.
Descriptions: A description of the load or equipment connected to each circuit.
Amperage Ratings: The current ratings for each circuit breaker.
Phase and Voltage Details: Indicating single-phase or three-phase connections and voltage levels.

This type of document is often used in electrical design and construction projects to specify the configuration of electrical panels and their circuits. It could be considered a critical input for systems like the one described, which automates the detection and extraction of data from such schedules to generate distributor-specific bills of material (BOMs).

In a preferred embodiment, the system includes a user interface for uploading documents and configuring distributor preferences, such as:
Default Selections: Dropdown menus for material specifications (e.g., copper/aluminum bussing), manufacturer preferences (e.g., Square D, Eaton, Siemens), and ERP template formats (e.g., SAP-compatible CSV, Oracle-compatible Excel).
Ambiguity Resolution: Interactive prompts to resolve missing data (e.g., fuse ratings) with override suggestions based on NEC standards and distributor practices.
Quote Templates: Custom formatting options allowing distributors to include their branding, special terms, and pricing markup calculations.
Workflow Integration: Configuration options for directing completed BOMs to specific departments or approval workflows within the distributor's organization.
Error Threshold Settings: Adjustable tolerance levels for ambiguities that require manual review versus those that can be auto-resolved.

Together, FIGS. 2A and 2B highlight the system's ability to process raw electrical documents into structured, distributor-ready BOMs by combining ML-based component detection, spatial OCR, and rules-based validation while providing distributor-specific customization.

FIG. 7 illustrates an internal panel schedule analysis stage executed by the system after a candidate panel schedule has been detected in an electrical document. The system crops a region around the panel schedule and applies OCR to locate a column header line containing textual labels such as “POLES,” “AMPS,” “LOAD,” or similar variants. Using keyword scoring and positional heuristics, the system identifies a panel-attribute region—typically positioned above or below the column headers—containing key panel level attributes such as bus amperage, main breaker rating, voltage, and enclosure type. Labels and values in this region are parsed as attribute pairs (for example, “BUS AMPERAGE: 200” is interpreted as a bus amperage attribute with a 200-ampere value), and these attributes are persisted as part of a structured panel-attribute record for subsequent rules-engine processing.

FIG. 8 illustrates an internal breaker analysis stage in which the system identifies and evaluates breaker specific columns and rows within the same panel schedule. After locating relevant columns for poles and amperage—whether expressed in a combined “POLES/AMPS” column or in separate “POLES” and “AMPS” columns—the system iterates over each populated row in those columns to infer breaker requirements for the panel. In some embodiments, the system applies quality filters to remove “junk” detections, such as amperage values that do not end in 0 or 5, OCR fragments that lack numeric characters, or rows obscured by revision clouds or low-quality scans. When a panel contains an insufficient number of valid breaker entries or an excessive proportion of junk values, the system may bail out of breaker analysis for that panel and instead emit only panel level attributes, thereby favoring safety and speed over speculative breaker reconstruction.

In certain implementations, the panel schedule analyzer distinguishes between panel-attributes and breaker attributes based on spatial cues, such as row spacing, grid-line density, and relative positioning to the detected column header line. This allows the system to handle schedules where panel attributes are positioned below the breaker table rather than above it, or where additional descriptive notes appear between the attribute block and the breaker grid. The analyzer uses whitespace void geometry and line segment detection to confirm that the candidate region is a gridlike table, and it discards irregular regions exhibiting insufficient horizontal and vertical line structure to avoid misclassifying legends or general notes as panel schedules.

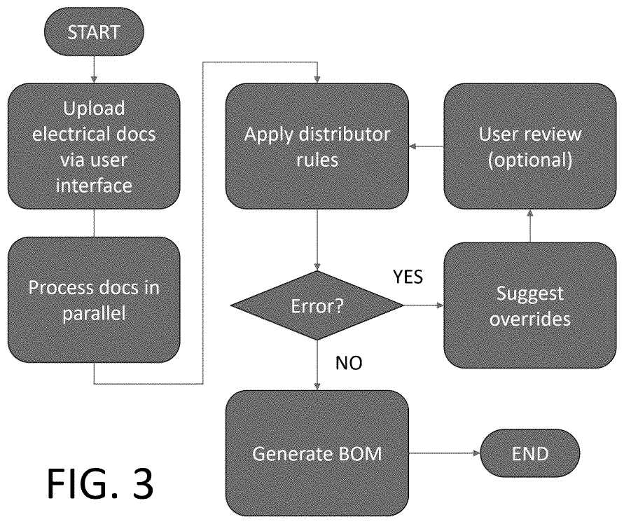

FIG. 3 illustrates the workflow for generating distributor-specific bills of material (BOMs) from electrical documentation, comprising five key stages that integrate machine learning (ML), optical character recognition (OCR), and rules-based validation.
1. Document Upload & Preprocessing. The workflow suitably begins with the upload of electrical submittal documents (e.g., panel schedules, one-line diagrams, and supporting technical specifications) through a user interface. These documents are accepted in PDF or vector formats to accommodate both rasterized and scalable vector graphics. Distributors configure preferences during upload, such as ERP template selection (e.g., CSV or Excel formats) and material defaults (e.g., copper vs. aluminum bussing). The interface validates file integrity and initiates preprocessing to standardize inputs for downstream analysis.
2. OCR & Component Detection. In a second step, the uploaded documents undergo parallel processing:—EasyOCR Extraction: A spatial OCR engine scans text and numerical data (e.g., “125A” breaker ratings, “Panel LP-1” identifiers) while mapping their coordinates within vector diagrams. This ensures contextual accuracy, such as associating a “225A” label with its corresponding circuit breaker in a one-line diagram. Detectron2 Analysis: A machine learning model trained on electrical components detects and classifies items (e.g., breakers, fuses) in vector drawings. Using a mask R-CNN architecture, the model identifies spatial relationships between components, such as feeder links between panels across multiple floors (see FIG. 2A).
3. Rules Engine & Error Prevention. A third step typically involves the system combining OCR/ML outputs with a distributor-specific rules engine to:
   Apply compliance checks (e.g., verifying ampacity ratings against wire sizes using lookup tables based on NEC Articles 310.15 and 240.6).
   Enforce material defaults (e.g., automatic copper bussing selection unless overridden) based on specifications of the job either submitted with the project plans or submitted separately by a user or administrator.
   Flag ambiguities or Identify distributor inventory limitations and suggest compliant alternatives via a user interface (e.g., substituting unavailable ‘30A fuses’ with distributor-stocked ‘40A fuses’ when manufacturer specifications and NEC 240.6(A) permit higher-rated protection for a detected 30A circuit).
   Cross-reference part compatibility (e.g., ensuring selected circuit breakers are compatible with specified panel types).
   Validate panel loading requirements per NEC Article 220.
   Detect potential specification conflicts (e.g., incompatible voltage ratings between connected components).

In a preferred embodiment, a decision node routes data to either error resolution (manual review) or direct BOM generation based on ambiguity detection and configurable threshold settings. When data ambiguities are detected (e.g., fused disconnects without specified fuse ratings), the system suggests valid replacements (e.g., 30A fuses for 30A circuits) via the user interface. These suggestions are generated using rules-based logic tied to detected circuit parameters, NEC standards, manufacturer recommendations, and the distributor's historical preferences, which can be continually refined through the feedback loop.

In some embodiments, prior to running full OCR and component detection pipelines on an entire project set, the system performs an E-sheet page filtering pass to identify electrical drawing sheets and discard non-electrical pages. As illustrated in FIG. 9, the system extracts corner crop regions from each page and applies OCR to detect bold alphanumeric sheet identifiers such as “E,” “E-102,” or similar prefixes that denote electrical drawings. When a page is classified as an E-sheet, the system further scans for textual cues like “PANEL SCHEDULES,” “ELECTRICAL SCHEDULES,” “DISCONNECT SCHEDULE,” or “TRANSFORMER SCHEDULE” to determine whether the page likely contains schedules or equipment that are relevant to BOM generation.

In some embodiments, the E-sheet filtering pipeline operates as a two-stage reduction process: first, the page set is narrowed to E-sheets based on corner identifier detection, and second, those E-sheets are further filtered to pages that contain panel, disconnect, or transformer schedules. Pages that fail these tests are discarded or deprioritized, thereby reducing the number of documents subjected to high cost OCR and ML analysis and decreasing the volume of non-electrical “junk” processed by downstream components. In some embodiments, configurable fallbacks are applied when sheet identifiers or schedule labels are ambiguous or absent, such as treating pages with partial matches as low confidence candidates while still routing them through later pipelines to avoid missing critical schedules.
4. BOM Generation & Export. In a fourth step, validated data is structured into a distributor-specific BOM, grouping identical part numbers (e.g., aggregating all “Square D QO 20A” breakers) and formatting outputs for ERP compatibility. The BOM includes metadata such as panel identifiers and compliance status, exported as CSV/Excel files or directly integrated with ERP systems (e.g., SAP, Oracle). A submittal package bundles the BOM with error logs and NEC compliance reports for auditing. The part number generator creates distributor-specific identifiers using component attributes (e.g., breaker amperage, poles, voltage) extracted during processing. For example, a 20A single pole breaker is mapped to ‘SQD-CB20-1P’ per Square D catalog conventions.
5. User Feedback Loop. one step may involve a feedback loop. Arrows in FIG. 3 illustrate a feedback mechanism where manual corrections (e.g., overriding copper bussing defaults) update the rules engine, refining future automation. This feedback-loop system ensures continuous improvement while maintaining audit trails for regulatory compliance. The user interface provides a dedicated module for reviewing automated suggestions (e.g., fuse ratings, material defaults). Users may accept, modify, or reject recommendations, with overrides logged for audit trails and fed back into the rules engine to refine future processing.

According to one method, the workflow illustrated in FIG. 3 may include the following steps:
1. Upload electrical documents (panel schedules, one-line diagrams) via user interface.
2. Process documents in parallel:
   a. EasyOCR: Extract text/data with spatial mapping.
   b. Detectron2: Detect components (breakers, fuses) in diagrams.
3. Apply distributor rules (copper defaults, NEC checks) and resolve errors:
   a. Flag missing specs→suggest valid replacements.
   b. Log overrides for audit trails.
4. Generate BOM with grouped part numbers and ERP-compatible formatting.
5. Export to ERP systems (SAP/Oracle) with submittal package (BOM +compliance reports).
6. User feedback loop for manual corrections→update rules engine.

FIG. 3, as shown, further illustrates an error prevention mechanism integrated into the automated system for generating distributor-specific BOMs. This flowchart demonstrates how the system identifies, resolves, and prevents errors during the BOM generation process. The workflow is designed to ensure accuracy, compliance, and efficiency by leveraging ML, optical OCR, and rules-based validation. Again, the process begins with the Upload Documents step, where users upload electrical submittal documents such as panel schedules, one-line diagrams, and transformer schedules via a user interface. These documents are accepted in various formats, including PDF and vector files. Once uploaded, the system transitions to the OCR & ML Processing stage, where EasyOCR extracts text and numerical data (e.g., breaker ratings and panel identifiers) while Detectron2 identifies electrical components (e.g., breakers, fuses) and their spatial relationships within vector diagrams. The extracted data is then passed to the Rules Engine, which applies distributor-specific logic such as material defaults (e.g., copper vs. aluminum bussing) and NEC compliance checks. At this stage, the system evaluates whether any errors or ambiguities exist. If an Error Detected? decision node identifies issues (e.g., missing fuse ratings or conflicting specifications), the workflow branches to an Error Resolution step. In this step, the system suggests valid overrides or prompts user input to resolve ambiguities. For example, if a fuse rating is missing, the system may recommend a valid option based on detected circuit parameters. Once errors are resolved or if no errors are detected, the process proceeds to BOM Generation, where a comprehensive bill of materials is created. The BOM includes grouped part numbers tailored to distributor preferences and formatted for ERP compatibility (e.g., CSV or Excel formats). Finally, in the Export BOM step, the system outputs the BOM along with supporting documentation such as error logs and compliance reports.

FIG. 12 illustrates an example rules-engine interface and output for panel configuration based on detected panel and breaker attributes. Given a structured panel-attribute record and a set of inferred breaker requirements from panel schedule analysis, the rules engine evaluates which manufacturer specific panel assemblies can satisfy the requested configuration while respecting constraints such as maximum bus current, permissible main breaker ratings, and enclosure styles. For example, if the detected schedule specifies a 200-ampere panel with a breaker whose amperage exceeds the maximum allowed for a particular panel family, the rules engine may automatically select a higher-capacity panel family that remains as close as possible to the requested rating—such as upgrading to a 300-ampere or 225-ampere family rather than defaulting to a 1600-ampere solution.

In some embodiments, the rules engine models a panel configuration in a manner analogous to a human designer by reconciling “what was detected” in the panel schedule with “what is possible” using manufacturer catalog data. The rules engine applies constraints on breaker counts, maximum breaker amperage per panel type, voltage compatibility, and physical space limits to prevent invalid configurations such as placing
a 600-ampere breaker in a 150-ampere panel. When conflicts cannot be resolved within a given panel family, the rules engine promotes the panel to a different family, adjusts accessory selections, or flags the configuration for manual review. The resulting configuration is translated into a set of manufacturer part numbers grouped by panel; these part numbers are then aggregated into the distributor-specific BOM and presented to the user for inclusion or exclusion in the exported CSV.

In additional implementations, the rules engine incorporates historical override data from prior projects to refine its selection heuristics. For example, when users repeatedly override aluminum-bussed panel selections with copper-bussed equivalents for a given customer, the rules engine may adjust default material preferences for that customer profile in subsequent runs. Similarly, if users consistently demote panels that the system has promoted beyond a certain amperage threshold, the rules engine can tighten its promotion logic to better approximate distributor preferences while still enforcing manufacturer and code-based constraints.

FIG. 3 suitably highlights the system's ability to automate error detection and resolution while maintaining flexibility for manual overrides when necessary. By integrating advanced ML/OCR technologies with rules-based validation, FIG. 3 demonstrates how the system ensures accurate and compliant BOM generation tailored to distributor workflows.

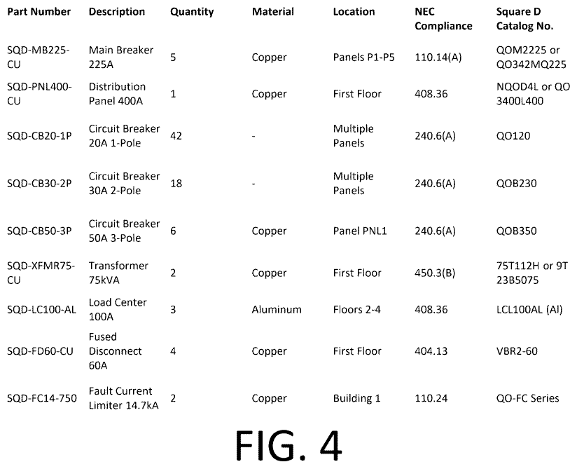

FIG. 4 illustrates an exemplary distributor-specific bill of materials (BOM) generated by the automated system based on electrical documentation comprising panel schedules and a building electrical riser diagram. The BOM is formatted in a tabular structure with columns for part number, description, quantity, material, location, and NEC compliance references. Specifically, the system has extracted and processed information from multiple panel schedules (shown in the panel schedule document if FIG. 2B) and the electrical riser diagram for Building 1, which depicts a multi-floor electrical distribution system in FIG. 2A.

The system employs a rules-based part number generation engine that dynamically constructs distributor-specific identifiers by combining manufacturer codes (e.g., “SQD” for Square D) with detected component attributes (e.g., amperage, poles, material type). For example, a detected 225A main breaker with copper bussing could generate the part number SQD-MB 225-CU, while a 14.7 kA fault current limiter could produce the number SQD-FC14-750. To ensure catalog validity, the system cross-references these autogenerated part numbers against manufacturer databases (e.g., Square D's product catalogs via API integration). When discrepancies arise—such as mismatched naming conventions (e.g., Square D's actual 225A main breaker part QOM2-225 versus the autogenerated SQD-MB225-CU)—the error prevention module substitutes invalid entries with distributor-stocked equivalents that match the technical specifications (amperage, material, voltage). This validation occurs in real time during BOM generation, with substitutions logged for user review. The system further refines part number rules through a feedback loop: manual overrides (e.g., replacing SQD-PNL400-CU with Square D's valid NQOD4L panel) update the rules engine to align future outputs with manufacturer conventions. FIG. 4 illustrates this process, where autogenerated part numbers (left column) are replaced with validated equivalents (right column) while preserving NEC compliance and material specifications. The integration of manufacturer catalog data ensures technical accuracy while maintaining compatibility with distributor ERP workflows.

The BOM demonstrates the system's ability to aggregate identical components across multiple panels, as evidenced by the quantity column, which shows the total count of each component type found throughout the building's electrical system. Additionally, the system has automatically verified NEC compliance for each component and included relevant code references (e.g., 110.14(A), 408.36, 240.6(A)). This example output illustrates how the automated system successfully transforms unstructured electrical documentation into a structured, distributor-ready BOM suitable for direct import into ERP systems, thereby significantly reducing manual processing time and potential errors in the switchgear quoting process. FIG. 4 illustrates a distributor-specific BOM generated by the system, including grouped part numbers (e.g., 42 units of ‘SQD-CB 20-1P’ 20A breakers) and NEC compliance verification. Copper bussing is applied as the default material per user preferences, with fault current limiters and transformers cataloged based on riser diagram analysis.

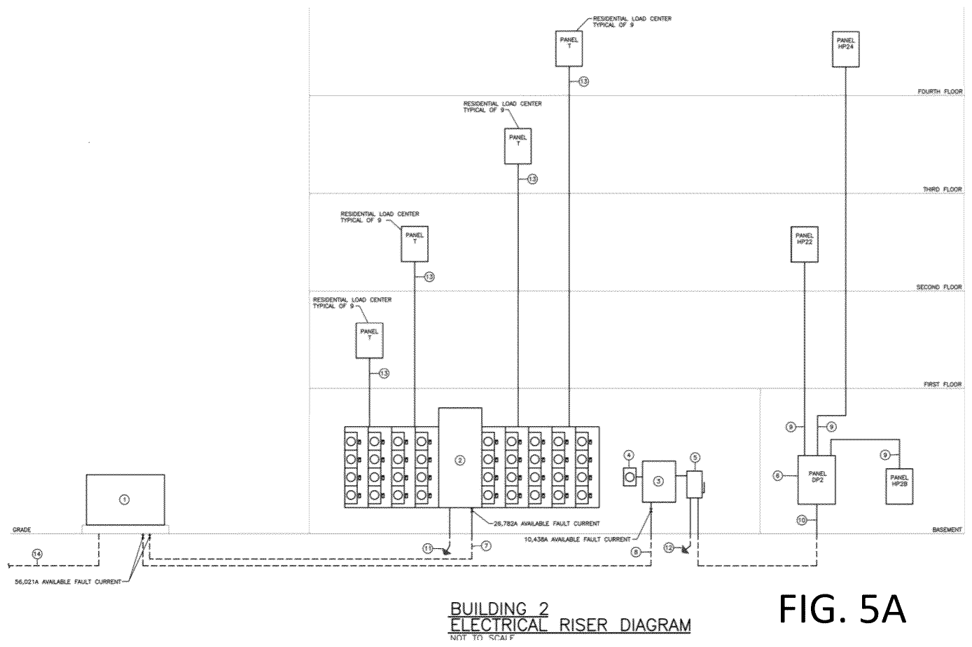

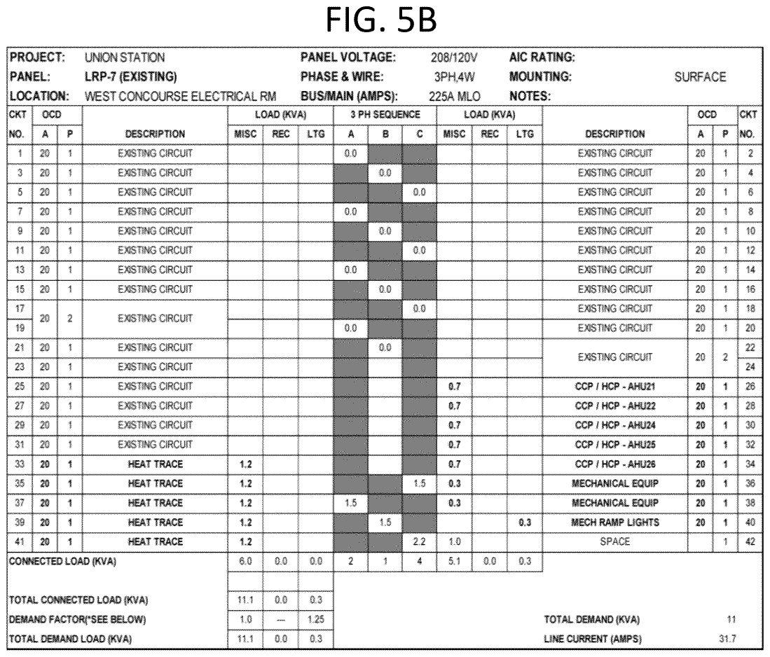

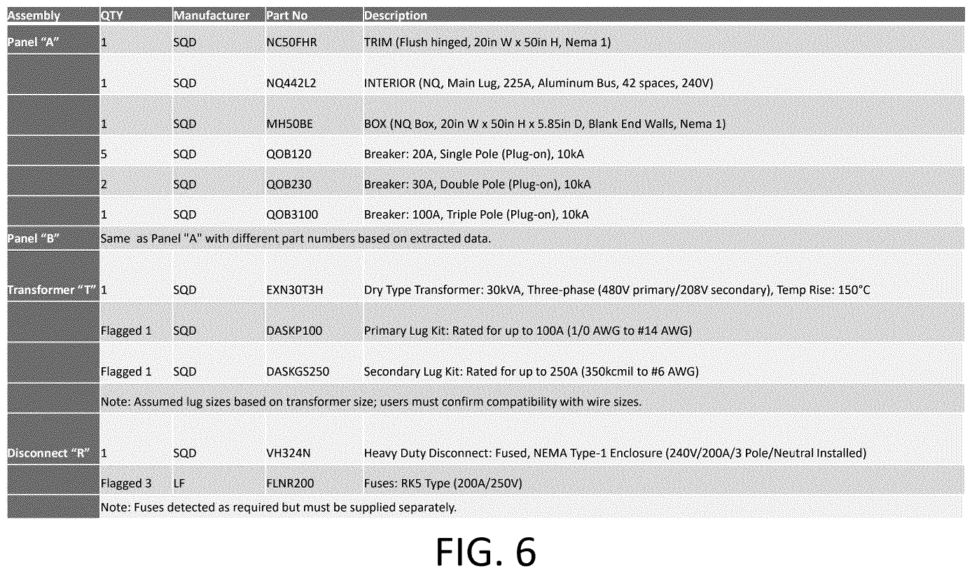

FIGS. 5A, 5B, and FIG. 6 illustrate another example of the system's operation, demonstrating its ability to process an electrical riser diagram (FIG. 5A) and a corresponding panel schedule (FIG. 5B) to generate a detailed BOM (FIG. 6). This example highlights the system's capability to extract data from heterogeneous electrical documents and produce distributor-specific outputs with real part numbers.

In FIG. 5A, the electrical riser diagram depicts the power distribution for a multi-story building. The diagram includes panels labeled “Panel A” and “Panel B,” as well as a transformer (“T”) and a disconnect (“R”). The system processes this diagram using the ML-based component detector (Detectron2) to identify key components, such as panels, transformers, and disconnects, while spatial OCR extracts text labels (e.g., amperage ratings, panel identifiers) and correlates them with their respective components.

In FIG. 5B, the corresponding panel schedule provides detailed information about circuits within “Panel A.” The system extracts circuit numbers, amperage ratings, and descriptions using spatial OCR and maps these attributes to detected components in FIG. 5A. For example, breakers with ratings of “20A” and “30A” are identified and grouped by their respective panels.

Based on the extracted data from FIGS. 5A and 5B, the system generates a detailed BOM as shown in FIG. 6. The output BOM includes real compatible part numbers sourced from distributor catalogs (e.g., Square D), grouped by assembly (e.g., Panel A, Panel B) with flagged items for further review if necessary. Some observations related to FIG. 6 include:
1. Panel Grouping: Components are grouped by their respective assemblies (e.g., Panel A and Panel B). Each panel's BOM reflects its unique configuration while maintaining consistency in formatting.
2. Flagged Items: Certain components (e.g., lug kits and fuses) are flagged for review due to potential inventory limitations or compatibility checks required by the user.
3. Compliance Validation: All components are validated against NEC standards and manufacturer specifications where applicable.
4. ERP Compatibility: The BOM is formatted for direct export into ERP systems with columns for part number, description, quantity, material type, location, and compliance codes.

This BOM of FIG. 6 suitably demonstrates the system's ability to process complex electrical documentation and produce accurate outputs tailored to distributor workflows.

Although the method and apparatus is described above in terms of various exemplary embodiments and implementations, it should be understood that the various features, aspects and functionality described in one or more of the individual embodiments are not limited in their applicability to the particular embodiment with which they are described, but instead might be applied, alone or in various combinations, to one or more of the other embodiments of the disclosed method and apparatus, whether or not such embodiments are described and whether or not such features are presented as being a part of a described embodiment. Thus, the breadth and scope of the claimed invention should not be limited by any of the above-described embodiments.

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like, and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that might be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases might be absent. The use of the term “assembly” does not imply that the components or functionality described or claimed as part of the module are all configured in a common package. Indeed, any or all of the various components of a module, whether control logic or other components, might be combined in a single package or separately maintained and might further be distributed across multiple locations.

In some embodiments, the system may be implemented as a standalone solution for distributors, while in other embodiments, the technology may be licensed to or integrated with existing manufacturer quoting systems, such as those offered by Square D, Eaton, or Siemens. The system architecture supports various deployment models, including cloud-based services accessed via subscription, on-premises deployment within distributor networks, or API-based integration with manufacturer platforms. The modular design allows for selective implementation of features based on distributor size, workflow requirements, and integration capabilities. Additionally, while the primary application focuses on electrical switchgear, the underlying technology is adaptable to other construction material domains where visual documentation analysis and BOM generation are required.

Additionally, the various embodiments set forth herein are described in terms of exemplary block diagrams, flow charts and other illustrations. As will become apparent to one of ordinary skill in the art after reading this document, the illustrated embodiments and their various alternatives might be implemented without confinement to the illustrated examples. For example, block diagrams and their accompanying description should not be construed as mandating a particular architecture or configuration.

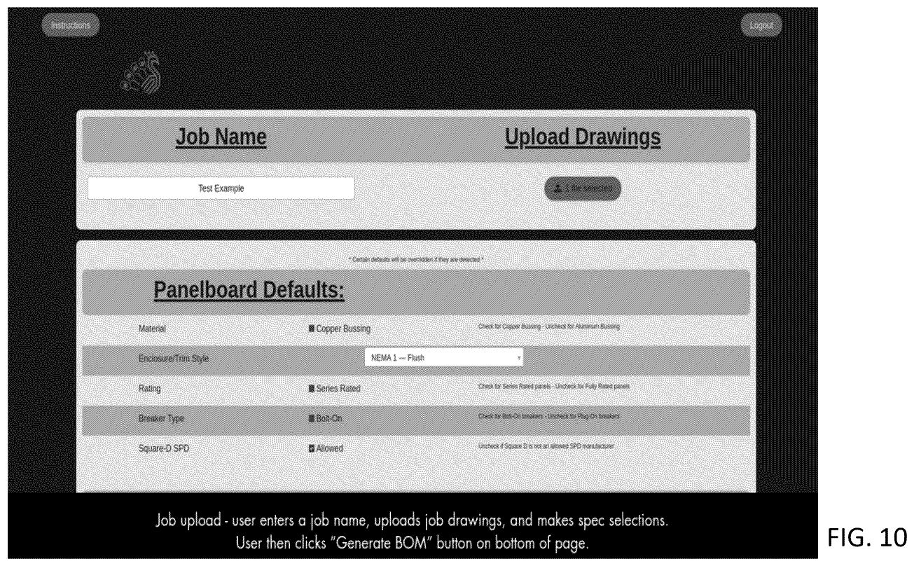

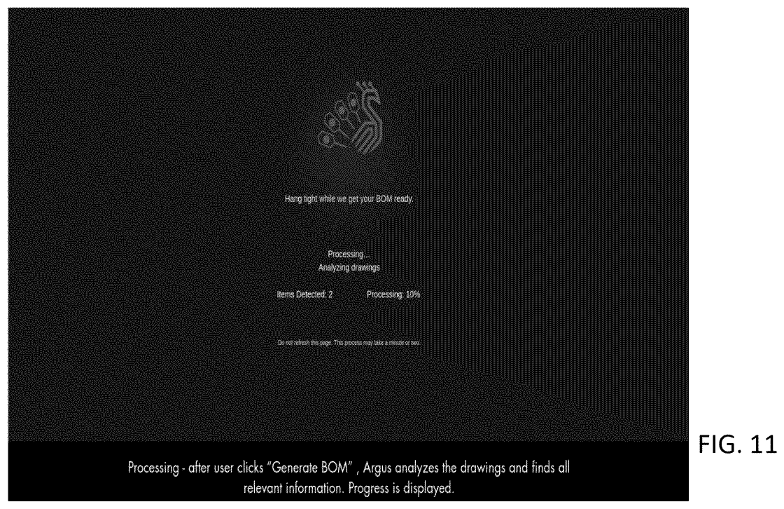

In conclusion, a recap of system operation is warranted. FIG. 10 is a user interface for uploading documents. As shown, a user uploads their documents/drawings and selects the defaults for the system to follow such as bussing material or enclosure rating. FIG. 11 is a loading page, suggesting the system takes the documents/drawings they uploaded (multiple pages) and looks for the “e-sheets” and specifically the pages containing schedules for panelboards, disconnects, and transformers. It cuts the document down to just those pages so there is less junk and faster processing. There are some fallbacks in case we don't find our labels or there is confusion. FIG. 12 is an output interface. As shown, the system then uses our whitespace void geometry analysis (no longer detectron here) to find any grids, tables, components, etc. that could be relevant. We filter out junk by looking at line density and horizontal/vertical lines (panel schedules are pretty clear grids so anything not a grid is removed). Then each detected schedules (using panel schedules as an example for ease of comprehension) are reviewed for specific key attributes. Each panel schedule, for instance, may be broken up into panel attributes and breaker attributes. The system scans for our attributes, e.g., panel attributes then breaker attributes. Typically panel attributes are output above the breaker attributes but they can be output below as well. Next, those panel and breaker attributes are sent to the rules engine which looks at everything detected before processing these detected attributes as described above. Basically the system looks for needs and what can be built with the manufacturer part numbers, and then the system builds the best possible panel that covers the requirements that were detected using the logic of the rules engine. Finally, part numbers are grouped for a clean output (see FIG. 12) so the user can see what part numbers are needed for each panel that the system built. They can then select to include them in the csv or not. When they hit the button to generate the csv, we then take all the included part numbers and build a csv for them containing all of the relevant part numbers.

All original claims submitted with this specification are incorporated by reference in their entirety as if fully set forth herein.

We claim:

1. A system for automated generation of distributor-specific bills of material (BOMs) comprising:
an input layer configured to receive (i) electrical submittal documents including panel schedules and one-line diagrams, and (ii) user-defined material defaults;
a document-filtering module configured to identify electrical drawing sheets by applying optical character recognition (OCR) to corner regions of pages to detect E-sheet identifiers and to select pages containing textual cues associated with panel schedules, disconnect schedules, or transformer schedules;
a panel-schedule analyzer configured to, for each detected panel schedule, locate a column-header line, identify a panel-attribute region, and parse label-value pairs from the panel-attribute region into structured panel attributes including at least bus amperage and main-breaker rating;
a breaker-analysis module configured to, for each detected panel schedule, identify columns corresponding to breaker poles and breaker amperage, analyze rows within the identified columns to infer breaker requirements, and filter out junk values based on one or more quality criteria;
a processing layer including:
(i) a spatial OCR engine that extracts text and assigns coordinates to correlate labels with detected components in vector drawings;
(ii) a machine-learning model trained to identify electrical components in vector drawings and output spatial relationships;
(iii) a rules engine that applies distributor-specific logic and manufacturer constraints to generate panel configurations and associated part numbers from the structured panel attributes and the inferred breaker requirements; and
(iv) an error-prevention module that flags ambiguities and provides override suggestions;
an output layer that generates a distributor-specific BOM with grouped part numbers and ERP-compatible formatting; and
an integration layer enabling direct export of the BOM to one or more ERP systems.

2. The system of claim 1, wherein the document-filtering module classifies a page as an E-sheet when OCR applied to a corner region detects a bold alphanumeric identifier beginning with an “E” character or an “E” character followed by numerals, and wherein the document-filtering module further scans the classified E-sheet for textual phrases including “PANEL SCHEDULES,” “ELECTRICAL SCHEDULES,” or “TRANSFORMER SCHEDULE” to prioritize the page for panel-schedule analysis.

3. The system of claim 1, wherein the panel-schedule analyzer distinguishes the panel-attribute region from breaker-attribute regions based on spatial cues comprising at least one of vertical offsets from the column-header line, grid-line density, row spacing, or whitespace-void geometry.

4. The system of claim 1, wherein the breaker-analysis module filters junk values by rejecting candidate amperage values that do not end in 0 or 5, by discarding OCR detections that lack numeric characters, or by discarding rows associated with low-confidence OCR scores, and wherein the breaker-analysis module omits breaker analysis for a panel when a threshold proportion of values are classified as junk.

5. The system of claim 1, wherein the machine-learning model comprises a Detectron2 architecture trained on annotated electrical component datasets to recognize breakers, disconnects, transformers, and panelboards in vector drawings and to output spatial relationships between the recognized components.

6. The system of claim 1, wherein the spatial OCR engine implements EasyOCR with coordinate mapping to correlate text labels with component positions in panel schedules and one-line diagrams.

7. The system of claim 1, wherein the rules engine enforces National Electrical Code (NEC) compliance by validating amperage ratings against wire sizes using lookup tables based on NEC 240.6(A) and related provisions, and by preventing configurations in which breaker ratings exceed limits for a selected panel family.

8. The system of claim 1, wherein the rules engine, when determining a panel configuration, automatically promotes the panel to a higher-capacity panel family when one or more detected breakers exceed a maximum allowable rating for a lower-capacity family while selecting the promoted family to be as close as possible to a requested bus amperage.

9. The system of claim 1, wherein the rules engine generates part numbers by concatenating manufacturer codes with detected component attributes including amperage, poles, material type, and enclosure type, and by appending suffixes indicating copper or aluminum bussing based on the user-defined material defaults.

10. The system of claim 1, wherein the error-prevention module: (i) cross-references detected components against a distributor inventory database; (ii) identifies unavailable components requiring substitution; and (iii) suggests alternative components having equal or higher ratings that are distributor-stocked and compliant with manufacturer specifications and NEC standards.

11. The system of claim 1, further comprising a feedback-loop module configured to capture user overrides of panel selections, material defaults, or suggested substitutions, and to update rules-engine logic based on the overrides for subsequent BOM generations associated with similar customers or projects.

12. The system of claim 1, wherein the output layer groups part numbers by panel and exports the BOM in a CSV template matching column layouts for at least one manufacturer-specific or distributor-specific ERP system.

13. A computer-implemented method for generating an electrical-switchgear bill of material (BOM), comprising:
receiving a multi-page document set containing electrical drawings and distributor or job specification requirements;
applying OCR to corner regions of pages to detect E-sheet identifiers and selecting a subset of pages that contain electrical drawing sheets;
scanning the selected pages for textual cues associated with panel schedules, disconnect schedules, or transformer schedules and selecting pages that contain such schedules;
for each detected panel schedule on the selected pages: locating a column-header line, identifying a panel-attribute region, parsing label-value pairs from the panel-attribute region into structured panel attributes, identifying breaker-attribute columns corresponding to poles and amperage, analyzing rows within the breaker-attribute columns to infer breaker requirements, and filtering out junk values according to one or more quality criteria;
detecting electrical components in vector diagrams using a trained machine-learning model;
extracting text from the document set using spatial OCR and mapping labels to components based on coordinates;
applying rules to assign part numbers, enforce material defaults, select panel configurations consistent with manufacturer constraints, and validate compliance with electrical-code requirements;
generating a BOM with aggregated part numbers grouped by panel; and exporting the BOM to an ERP system in a CSV or spreadsheet format.

14. The method of claim 13, further comprising bailing out of breaker analysis for a panel and emitting only panel-level attributes when a number of breaker-row values classified as junk exceeds a configurable threshold.

15. The method of claim 13, wherein applying the rules comprises selecting a minimal-capacity panel family that satisfies both detected panel attributes and inferred breaker requirements while preventing configurations in which breaker ratings exceed allowable limits for the panel family.

16. The method of claim 13, wherein generating the BOM comprises concatenating manufacturer codes with component attributes to create part numbers, grouping identical part numbers across multiple panels, and appending NEC code references associated with the validated configurations.

17. The method of claim 13, further comprising logging user overrides of automatically selected panels or substitutions and updating rules used in subsequent executions of the method in response to the logged overrides.

18. A non-transitory computer-readable medium storing instructions that, when
executed by one or more processors, cause a system to perform operations comprising:
processing uploaded electrical documents to detect E-sheets using corner-region OCR, panel schedules using textual cues, and one-line diagrams using machine-learning-based component recognition;
extracting text fields from panel schedules and correlating the text fields with detected panel and breaker attributes via spatial OCR;
applying user-configured rules and manufacturer constraints to resolve ambiguities in material specifications, panel-family selections, and component substitutions;
generating a distributor-specific BOM with grouped part numbers, NEC compliance codes, and panel-level groupings; and
providing a user interface for overriding system suggestions, storing the overrides, and updating rules-engine logic based on the stored overrides.

19. The medium of claim 18, wherein the instructions further cause the system to classify breaker-row values as junk based on value patterns, OCR confidence scores, or inconsistency with standardized amperage sets, and to omit junk values from breaker-count aggregation.

20. The medium of claim 18, wherein the instructions further cause the system to export the BOM in templates having columns including at least Part Number, Description, Quantity, Material, Panel Identifier, and NEC Compliance, formatted for ingestion by distributor ERP systems.
